(19) United States
(12) Patent Application Publication
(10) Pub. No.: US 2007/0232393 A1
(43) Pub. Date: Oct. 4, 2007

(54) Gaming tournament based on predicting results of contests within a real sports league

(76) Inventor: Dennis R. Dreyer, Fairmont, MN (US)

Correspondence Address: INVENTION PROTECTION ASSOCIATES, LLC, 121 W. CHESTNUT ST., #1103, CHICAGO, IL, 60610-3152, US

(21) Appl. No.: 11/694,949

(22) Filed: Mar. 31, 2007

Related U.S. Application Data
(60) Provisional application No. 60/744,124, filed on Apr. 1, 2006.

(51) Int. Cl. A63F 13/00

(52) U.S. Cl. 463/29

(57) ABSTRACT

A gaming tournament within which entry fee paying players are divided into groups and subgroups to simulate the competition structure of a real sports league and in which players engage in a succession of preliminary rounds of head-to-head game prediction matches in order to determine the players in each subgroup that advance into playoff rounds of similar matches in order to determine an overall tournament winner is provided.

This nonprovisional application claims the benefit of provisional application 60/744,124.

### BACKGROUND OF THE INVENTION

The present invention generally relates to sports gaming, and it is specifically directed to a method of conducting a gaming tournament in which players are subdivided into groups to simulate the competition structure of a real, professional sports league, predict the outcomes of league contests and are rewarded for not only winning the tournament, but also for a variety of accomplishments made during progression of the tournament.

Traditionally, tournament style sports gaming methods have fallen within either of two basic categories: (a) fantasy methods and (b) outcome-based methods. Fantasy methods are generally characterized by the fact that players select or are assigned player members of sports teams and are rewarded based on the players' statistical performances during actual contests.

For instance, in a typical fantasy league based upon National Football League (“NFL”) play, the entry fee-paying players, first, conduct a selection draft in which they select actual NFL players and intra-team units (ex.: Minnesota Vikings' team defense) to comprise their respective fantasy teams. For each week of scheduled NFL games, the fantasy league teams are paired in head-to-head competition, and each team's weekly score is calculated based on the statistical achievements of the NFL players/units for that week. For example, the fantasy league's scoring system might call for fantasy teams to receive 6 points for each touchdown scored by a player, 2 points for every 30 yards of rushing, 2 points for every 90 yards of passing and so forth. NFL fantasy league scoring systems' are widely varied, but one general commonality is that the outcomes of NFL games, in terms of who wins and loses, have little or no bearing on fantasy scoring; usually, only individual players' performances affect fantasy scoring. Regardless, the winner of each fantasy league weekly pairing is determined by whichever of the two fantasy teams receives the higher cumulative score.

The pairings are changed each successive week to promote competitive balance, and players compile win-loss records. Then, after several weeks of competition, some of the fantasy teams, in reward for having the league's best win-loss records, will advance to a fantasy league playoff. Typically, a fantasy league will use some or all of the final 3 or 4 weeks of the NFL regular season game schedule to conduct its fantasy playoff. Whatever the format, the single fantasy team that emerges victorious from the fantasy playoff is crowned the league winner and, consequently, is awarded a predetermined financial prize. Often, that prize is simply the aggregate amount of fees paid by each player as a condition of fantasy league entry. However, some leagues reserve portions of their fee pools to reward other significant league accomplishments such as the best win-loss record entering the playoff.

Outcome-based methods are characterized by the fact that players predict the outcomes of real sporting contests, and a player is rewarded for making the most correct predictions. Some methods call for predicting the outright winners of contests, some call for predicting teams to cover point spreads published for contests and yet other methods call for predicting contest scores. Regardless of what particular outcomes are to be predicted, there is a commonality amongst virtually all of the outcome-based gaming methods of which the inventor is aware. To wit, they generally reward only players having the highest aggregate number of correct picks over a given timeframe, be it a week or an entire tournament season.

For example, in a typical outcome-based tournament in which NFL game winners are to be picked, entry fee-paying players predict the winner of each NFL game played each week. After several weeks, the tournament ends, and whoever has the greatest number of correct picks wins the entire entry fee pool as his prize (although, some amount may be reserved to compensate a tournament administrator). Alternatively, a portion of the fee pool may be used to pay weekly awards to players with the highest correct pick totals for each week of tournament play.

In another example of outcome-based methodology which is most prominently used in conjunction with the National Collegiate Athletic Association (“NCAA™”) basketball tournament, players attempt to pick the overall tournament winner by picking winners of games in each successive round of the NCAA™ tournament. Typically, there is a hierarchical scoring system in which players are awarded increasingly greater numbers of points for correct picks as the tournament rounds progress. For example, a correct pick in a first round game is worth 1 point; a correct second round pick is worth 2 points and so on. Whoever winds up with the highest cumulative score at the conclusion of the real NCAA™ tournament is declared the game winner and, therefore, is awarded the predetermined prize.

Nevertheless, the present inventor is not aware of any existing fantasy or outcome-based gaming tournament in which its players are subdivided into intra-competitive subgroups (much like teams of NFL teams are divided into “conferences” which are, themselves, subdivided into “divisions”) and in which: (1) one or more players are financially rewarded, throughout preliminary rounds of tournament play, for periodic accomplishments (ex: for week's top performance), (2) multiple players are financially rewarded for winning their respective subgroups and are advanced to playoff rounds of tournament play and (3) a single player is financially rewarded for winning the tournament playoff. The present invention substantially fulfills an existing need for such a tournament method.

### SUMMARY

The present invention generally provides a gaming tournament, and it specifically provides a tournament in which players are divided into groups and subgroups to simulate the competition structure of a real professional sports league (e.g., National Football League) and in which players engage in a daily or weekly succession of preliminary rounds of head-to-head game prediction matches in order to determine the top performing players in each subgroup that advance into playoff rounds of similar matches in order to determine an overall tournament winner. Furthermore, by collecting entry fees from all players and then awarding portions of the entry fee pool to the top performing players of each preliminary round, to the top performing players of each group and to the overall tournament winner, the present tournament continuously makes financial rewards achievable for all players throughout their entire periods of tournament participation.

Therefore, it is an object of the present invention to provide a gaming tournament in which enough players are entered in order that they may be placed in grouped competition which simulates the competition structure of an actual sports league such as the NFL, Arena Football League (“AFL”), National Hockey League (“NHL”), National Basketball Association (“NBA”), Major League Baseball (“MLB”), etc.

It is another object of the present invention to provide a gaming tournament having an affordable entry fee. By including as many players as there are teams in, for example, the NFL, a relatively large fee pool can be accumulated from small individual entry fees.

It is yet another object of the invention to provide a tournament style gaming method which can be easily administered, with respect to match scheduling and player pairing, without the risk of any two players being pitted against each other an inordinate number of times. Ideally, the tournament simply adopts the games schedule of the real sports league after which its player grouping structure is modeled, and the players' weekly head-to-head match pairings are shuffled in accordance with the real league's week-to-week game match-ups.

Finally, is another object of the present invention to provide a tournament style gaming method which has a reward structure designed to give every player a tangible incentive to remain interested in the tournament and motivated to compete well irrespective of the player's current probability of advancing to the tournament's playoff. In many prior art tournaments, one is entitled to a financial award only upon qualifying for an advanced round of play (i.e., a playoff) or for winning the tournament. Contrastingly, under the present method, a player that has consistently performed poorly throughout every week of preliminary season play can still win a weekly cash award for making the most correct picks during the final week of preliminary play.

### BRIEF DESCRIPTION OF THE DRAWINGS

FIG. 1 depicts a hypothetical grouping of players entered into the tournament of the present invention. In this view, the respective win-loss records of each player, after completing thirteen weeks of preliminary season tournament play, are shown.

### DETAILED DESCRIPTION OF THE PREFERRED EMBODIMENTS

In a preferred embodiment of the tournament of the present invention, a divisional competition structure which mirrors that of the NFL is created. To wit, a number of players which corresponds to the total number of NFL teams are entered into the tournament upon each of them paying a $30 entry fee to a tournament administrator. At present, that translates to thirty-two players being entered and, therefore, a fee pool of $960 being collected. However, it should be noted that the required entry fee amount as well as the various prize amounts described hereinafter are completely arbitrary and subject to the discretion of a tournament administrator.

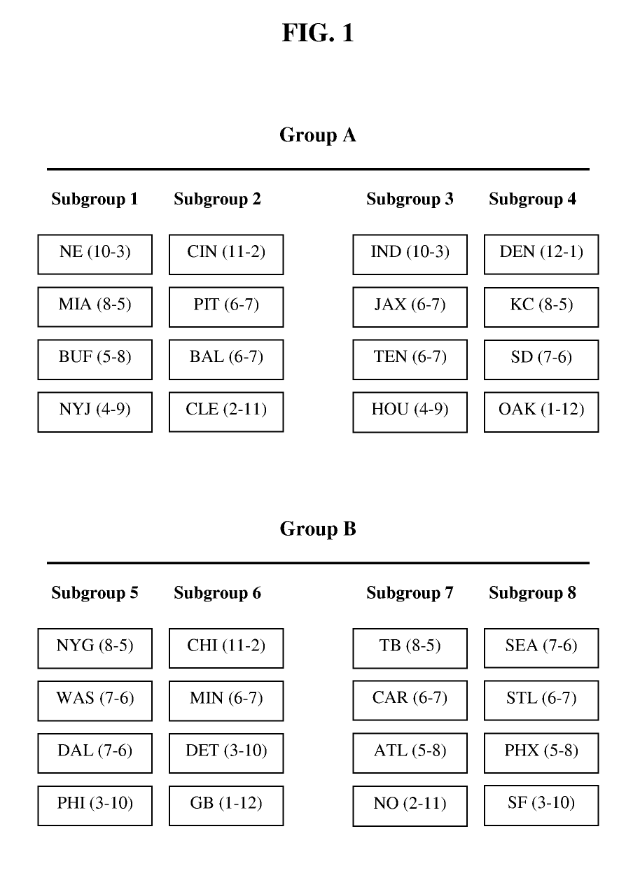

Nevertheless, as illustrated in FIG. 1, the thirty-two tournament players are divided into two separate groups and then subdivided into eight separate, 4-team subgroups (each group comprising four subgroups), and each player assumes the identity of a different NFL team. The tournament schedule is comprised of a preliminary season followed by a playoff season. In this preferred embodiment, the playoff season lasts four weeks. The length of the preliminary season is arbitrary, but for discussion purposes, it shall be assumed as thirteen weeks in this preferred embodiment. By deadlines prior to the start of each NFL week of action, the tournament players must submit to the administrator their predictions regarding both: (a) the straight-up winners of every NFL game slated for that week and (b) the total number of points to be scored in a designated NFL game (ex: a Monday game).

The tournament employs a first scoring system to award a weekly prize each week of the preliminary season. More specifically, at the end of each week of preliminary play, the player totaling the highest number of correct picks is awarded a $15 weekly prize. If multiple players tie for the most winning picks for the week, their designated game score predictions are used to break the tie. For example, the tied player whose designated game prediction is closest to that game's actual scoring total wins the tie breaker and, therefore, the entire weekly prize. However, if two or more players remain tied, those players will share the weekly prize equally. The thirteen weekly prizes awarded account for $195 of the fee pool. Preferably, at conclusion of the preliminary season, another $60 is awarded to the player(s) totaling the most correct NFL winner predictions.

The tournament also employs a second scoring system for determining the subgroup winners that qualify for a tournament playoff conducted to decide the tournament overall winner. Again, all thirty-two tournament players adopt the identity of a different NFL team. So, each week of the preliminary season, players are paired into head-to-head matches. Within each weekly match, whichever opponent makes the most correct game winner predictions earns a tournament win (“W”), and the other opponent records a tournament loss (“L”) for that week. Where two head-to-head opponents make an equal number of correct picks, their designated game total score predictions are used to break the tie in the same manner as explained above, and if a tie remains, both players record a tournament tie (“T”) for that week. The tournament player pairings are reshuffled weekly in accordance with the NFL team pairings.

At the end of the preliminary season, the eight players accumulating the highest winning percentages in their respective subgroups are declared subgroup winners. In the event of an intra-subgroup tie, a tiered tie breaking analysis may be employed. All eight subgroup winners are awarded $30 prizes, and they are further rewarded with advancement to the tournament's playoff season. Preferably, the two players from each group (four total) who amassed the highest winning percentages among all non-subgroup winners also advance to the playoffs as wildcard qualifiers, but without receiving cash rewards for advancing.

In this preferred embodiment of the new tournament, the playoff is a four week season. During its first round (week), the two subgroup winners of highest winning percentage in each group receive a first round bye. Thus, four players earn the bye. This leaves the remaining two subgroup winners and two wildcard winners from each group to square off in one-on-one, intra-group playoff matches that are conducted like preliminary season matches. Then, the playoff first round match winners advance to a playoff second round which incorporates the players that enjoyed first round byes. The second round is conducted similar to the first round. The two players from each group that win their second round matches advance to a third round which is conducted similar to the first and second rounds, and the two third round winners then square off in a fourth and final round match. The winner of that final match is declared the tournament winner and is awarded $300—the largest single prize issued in the tournament. The remainder of the fee pool ($165) is retained by the tournament administrator.

Of course, the same inventive method could be used to simulate the competition structure of other professional or collegiate sports leagues, and the subjects of player predictions could differ accordingly. Furthermore, it is generally understood that substitutions and equivalents for various elements set forth above may be obvious to those skilled in the art. Therefore, the full scope and definition of the present invention is to be set forth by the claims that follow.

What is claimed is:

1. A method for conducting a gaming tournament, the method comprising:
entering a plurality of players into the tournament;
scheduling a preliminary season of tournament competition, wherein the preliminary season is divisible into a succession of time periods;
dividing the plurality of players into at least two groups, wherein each group contains at least two players;
pairing individual players into head-to-head matches within each time period, wherein the two players of a head-to-head match attempt to predict the winners of a set of real sports league contests scheduled to occur within the corresponding time period;
determining match winners, wherein the players of each match that, relative to their respective match opponents, correctly predicted the greater number of winners of the real contests occurring within the time period corresponding to the match are declared match winners;
determining time period winners, wherein the player that correctly predicted the greatest number of winners of the real contests occurring within the corresponding time period is declared a time period winner;
determining group winners, wherein the players of each group that, relative to other players within their respective groups, have the greatest number of match wins at conclusion of the preliminary season are declared group winners;
advancing the group winners to a playoff season of tournament competition; and
determining a playoff winner.

2. The method of claim 1, further comprising collecting tournament entry fees from said tournament players.

3. The method of claim 2, further comprising awarding a portion of the entry fee pool the player(s) tallying the most match wins during the preliminary season.

4. The method of claim 2, further comprising awarding portions of the entry fee pool to time period winners, group winners and the playoff winner.

5. The method of claim 1, further comprising employing at least one tie breaking method to break ties in determining time period winners, match winners and group winners.

6. The method of claim 1, wherein said real sports league is the NFL™, NHL™, NBA™ or MLB™

7. The method of claim 1, wherein the step of selecting tournament players comprises selecting a total number of players that corresponds with the total number of teams in said real sports league.

8. The method of claim 7, wherein the step of scheduling a preliminary season comprises simulating at least part of the contest schedule of said real sports league.

9. The method of claim 1, wherein the step of dividing players into groups comprises dividing players into a competition structure that simulates that of said real sports league.

10. The method of claim 9, wherein said real sports league is the NFL™, NHL™, NBA™ or MLB™
